(19) United States
(12) Patent Application Publication
(10) Pub. No.: US 2004/0153189 A1
(43) Pub. Date: Aug. 5, 2004

(54) Rating method and rating apparatus for production process

(75) Inventors: David Emerson, Carrollton, TX (US); David Culpin, Isle of Wight (GB); Noriyuki Togami, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: YOKOGAWA CORPORATION OF AMERICA, Carrollton, TX; YOKOGAWA ELECTRIC CORPORATION, Tokyo (JP)

(21) Appl. No.: 10/684,369

(22) Filed: Oct. 15, 2003

(30) Foreign Application Priority Data
Feb. 5, 2003 (JP) 2003-028163

(51) Int. Cl. G06F 19/00

(52) U.S. Cl. 700/108

(57) ABSTRACT

This invention provides a rating method and rating apparatus for a production process having the following features. Plural performance rating items are prepared in advance as rating indexes for the production process. Addition or subtraction of points or another arithmetic operation for rating is performed in accordance with whether or not a currently executed production process satisfies the respective performance rating items, thus calculating a final rating value. The final rating value is displayed in a graph. This enables comprehensive rating of performance of an entire production process and multilateral analysis.

### BACKGROUND OF THE INVENTION

1. Field of the Invention

This invention relates to a rating method and a rating apparatus for a production process that is useful for batch processes applied to chemical, pharmaceutical and food industries as well as continuous processes and discontinuous processes.

2. Description of the Related Art

Recently, production efficiency has been improved utilizing information technology (IT). This requires a production site to construct a mechanism for efficiently producing demanded products at a profit-making cost. To check whether production is efficient or not, a technique that enables proper rating of the production process is necessary.

One of production processes is a batch process. In the following description, a batch process is used as an example. Conventionally, a technique such as KPIs (key performance indicators) has been used as a rating method for a batch process.

The procedure for rating a batch process using the KPIs technique will be described.

Individual parameters used for rating a batch process include, for example, production cycle time, amount of production, quality of product, production cost and the like.

In the KPIs technique, a certain parameter is estimated. Achievement data of the estimated parameter is compared with a mean value and a standard deviation of this parameter. The result of the comparison is expressed, for example, by a score of 0 to 100%. The mean value and the standard deviation of each parameter are a mean value and a standard deviation of production cycle time, amount of production and the like based on the same revision as a recipe revision that is currently being executed in the batch process. The achievement data is acquired by the execution of the batch process.

In this manner, in the KPIs technique, the batch process is rated on the basis of the position of achievement data of a certain parameter in relation to a mean value and a standard deviation of this parameter.

However, the batch process rating method using the KPIs technique has a problem that it enables only one-dimensional rating because the result of rating is based on only one parameter, and that it is difficult to comprehensively rate an entire batch process.

FIG. 1 shows an exemplary display of the result of rating in the conventional technique.

As shown in FIG. 1, the vertical axis represents production cycle time and the horizontal axis represents batch ID. In the example of FIG. 1, the production cycle time of each batch is shown in the form of a bar chart. FIG. 1 is a graph showing an analysis of variation in the production cycle time. In the graph, a mean value and a standard deviation of the production cycle time are indicated by horizontal lines. In the example of FIG. 1, the mean value is 0.32 and the standard deviation is 0.02.

FIG. 2 shows another exemplary display of the result of rating.

As shown in FIG. 2, the vertical axis represents the number of batches and the horizontal axis represents short, medium and long production cycle times. The short, medium and long production cycle times are predetermined time periods formed by sectioning the production cycle time. FIG. 2 is a graph showing an analysis of the frequency of variation in the production cycle time.

The results of rating shown in FIGS. 1 and 2 are the results of one-dimensional analyses of data of a batch process based only on the production cycle time, and the performance of the entire batch process cannot be rated comprehensively.

### SUMMARY OF THE INVENTION

In order to solve the foregoing problem, it is an object of this invention to realize a rating method and a rating apparatus for a production process that enable comprehensive rating of performance of an entire production process and multilateral analysis by preparing plural performance rating items in advance as rating indexes for the production process, then performing addition or subtraction of points or another arithmetic operation for rating based on whether a currently executed production process satisfies the respective performance rating items so as to find a composite value, and displaying the final rating value in a graph.

### BRIEF DESCRIPTION OF THE DRAWINGS

FIG. 1 shows an exemplary display of the result of rating in a conventional technique.

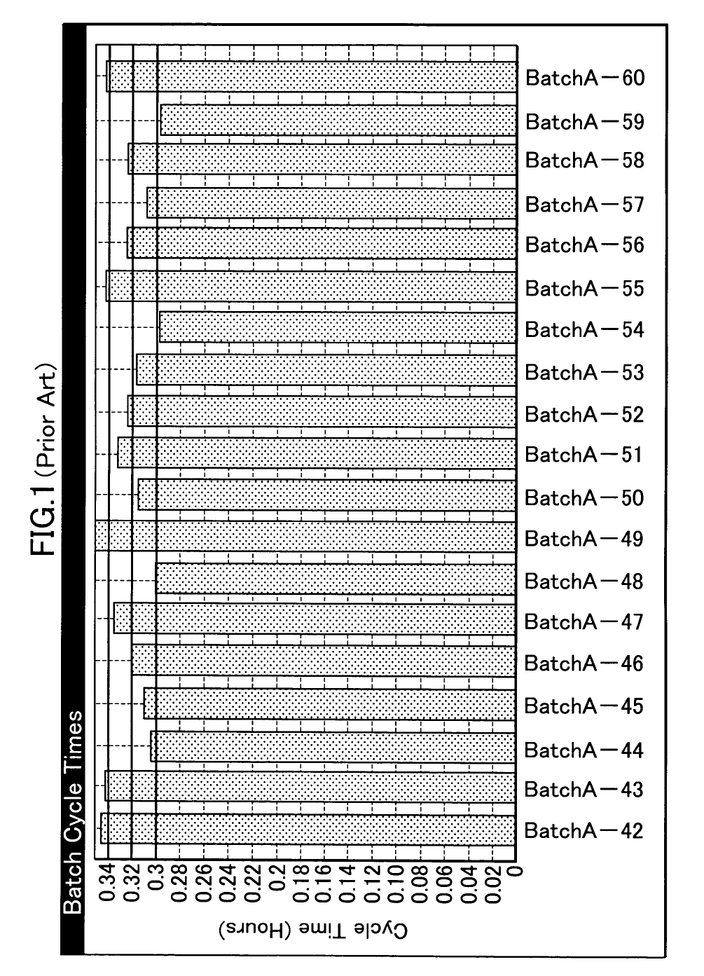

FIG. 2 shows an exemplary display of the result of rating in a conventional technique.

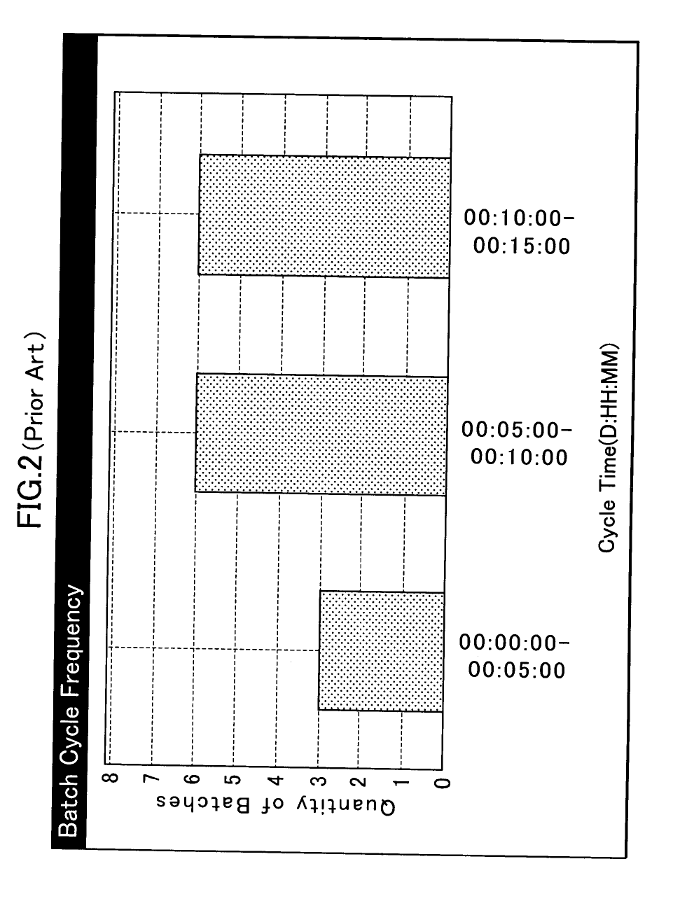

FIG. 3 is a structural view showing an embodiment of this invention.

FIG. 4 shows exemplary performance rating items and rating values.

FIG. 5 shows a procedure for performance rating.

FIG. 6 shows the procedure for performance rating.

FIG. 7 shows the procedure for performance rating.

FIG. 8 shows the procedure for performance rating.

FIG. 9 shows the procedure for performance rating.

FIG. 10 shows the procedure for performance rating.

FIG. 11 shows the procedure for performance rating.

FIG. 12 shows an exemplary display of the result of performance rating.

FIG. 13 shows an exemplary display of the result of performance rating.

FIG. 14 shows an exemplary display of the result of performance rating.

FIG. 15 shows an exemplary display of the result of performance rating.

FIG. 16 shows an exemplary display of the result of performance rating.

### DESCRIPTION OF THE PREFERRED EMBODIMENTS

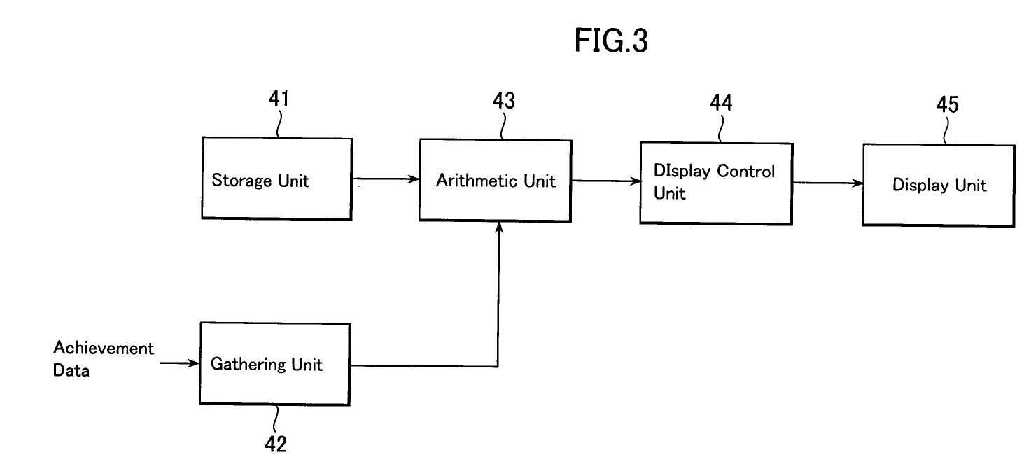

This invention will now be described in detail with reference to the drawings. FIG. 3 is a structural view showing an embodiment of this invention.

In FIG. 3, a storage unit 41 stores plural data including performance rating items associated with rating values, as rating indexes for a production process.

A gathering unit 42 gathers necessary achievement data for rating when a production process is executed.

An arithmetic unit 43 judges whether the executed production process satisfies conditions defined by the performance rating items, on the basis of the achievement data. Initially, a reference score is provided as a default value. In accordance with the result of the judgment by the arithmetic unit 43, a point or points are added to or subtracted from the score, or another arithmetic operation for rating is performed. Another arithmetic operation for rating may be, for example, multiplication, division or the like. When the production process satisfies the conditions defined by the performance rating items, the reference score is multiplied by a number larger than 1. When the conditions are not satisfied, the reference score is multiplied by a number smaller than 1.

This realizes comprehensive rating of the production process based on the plural performance rating items.

For example, in the case of a batch process, when a batch or unit recipe ends, the gathering unit 42 gathers achievement data of the batch. The arithmetic unit 43 performs performance rating calculation of the batch or unit recipe. The performance rating is to rate the achievement of an executed batch or unit recipe, using a value of 0 to 100%. A batch or unit recipe of 0% indicates the least performance, and 100% indicates the best performance.

A display control unit 44 prepares data for displaying a graph showing the result of the rating by the arithmetic unit 43. A display unit 45 displays a graph showing the result of the rating by the arithmetic unit 43 on the basis of the data prepared by the display control unit 44.

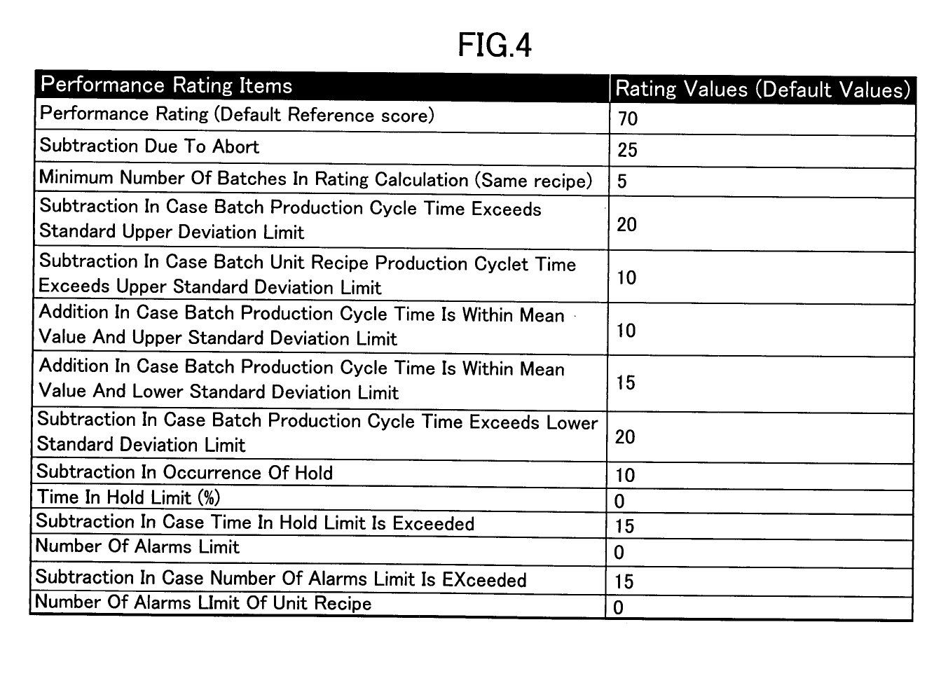

FIG. 4 shows exemplary performance rating items and rating values.

FIG. 4 shows exemplary performance rating items of a batch process. The performance rating is carried out by comparing rating data such as production cycle time, hold, abort and the like with achievement data of a batch, on condition of a basic recipe or unit recipe based on the same revision. For example, the performance rating is calculated on the basis of reference score of 70%. Depending on whether or not the gathered achievement data satisfies the rating items shown in FIG. 4, a rating value is added to or subtracted from the reference score of 70%, or another arithmetic operation for rating is performed. Each rating item and rating value can be added or adjusted.

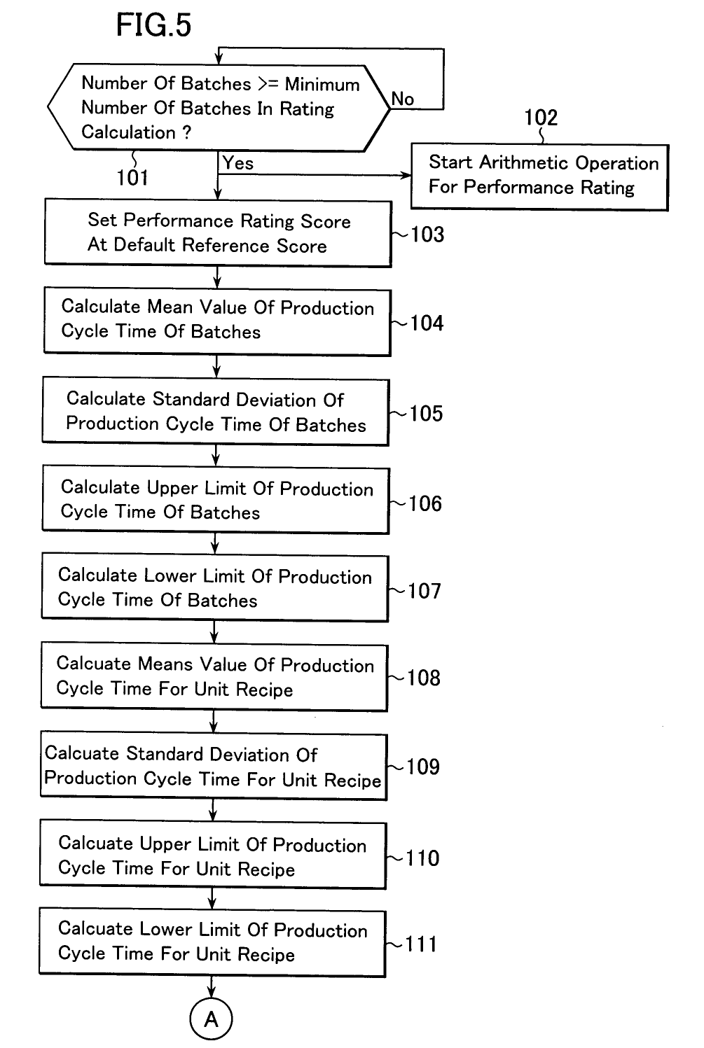

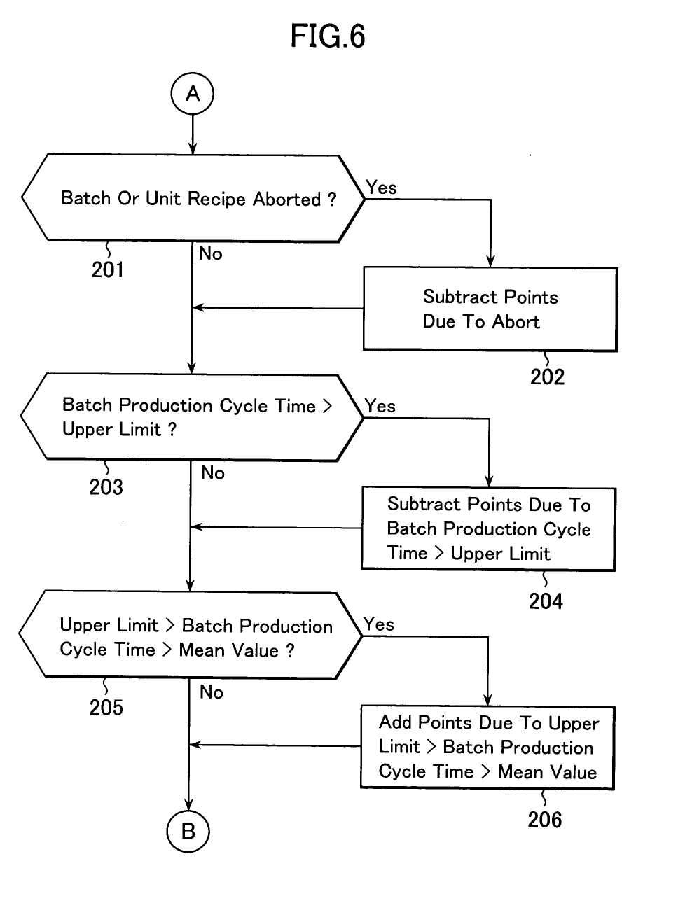

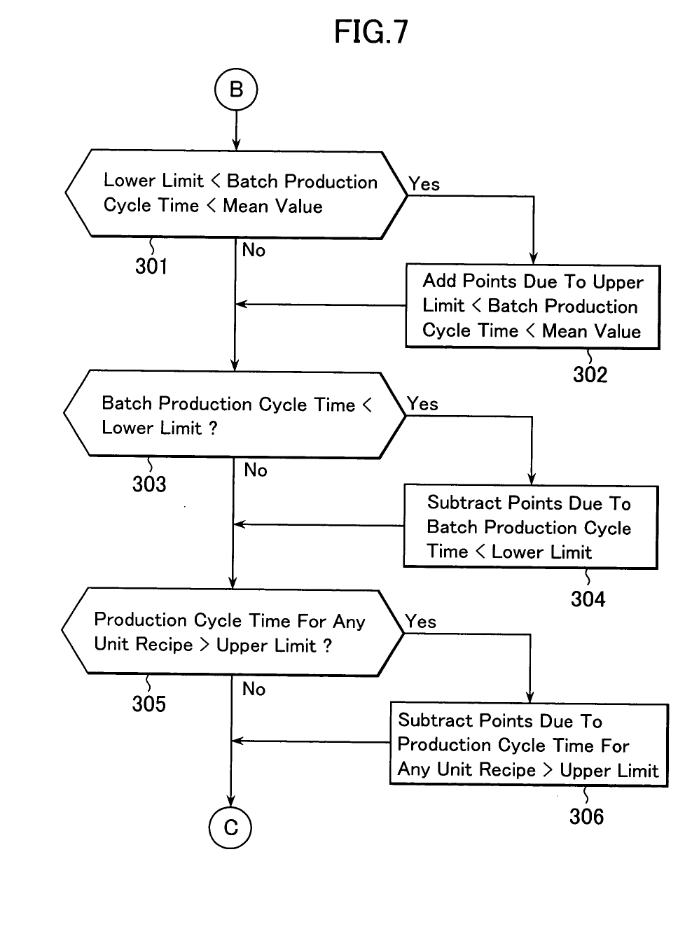

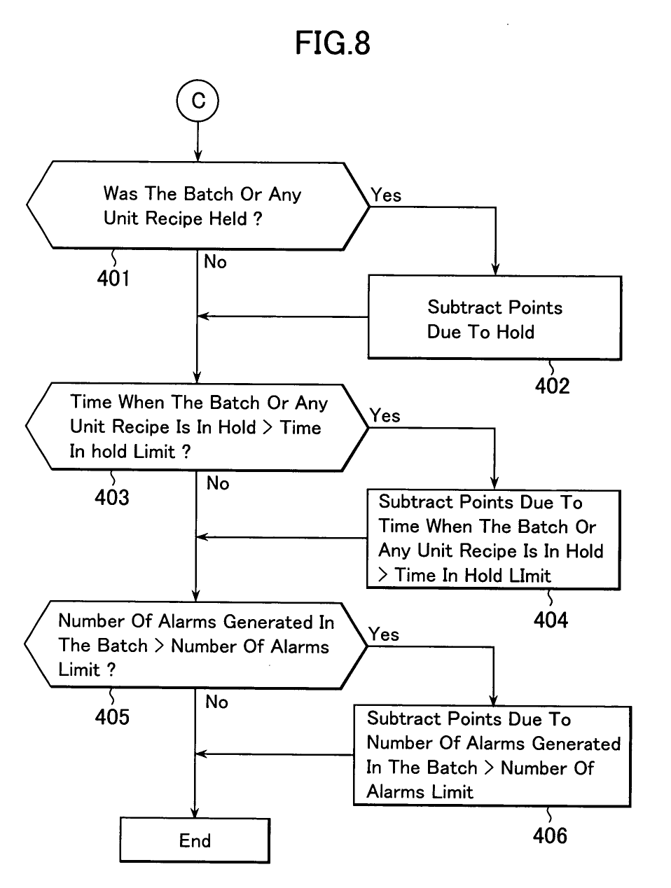

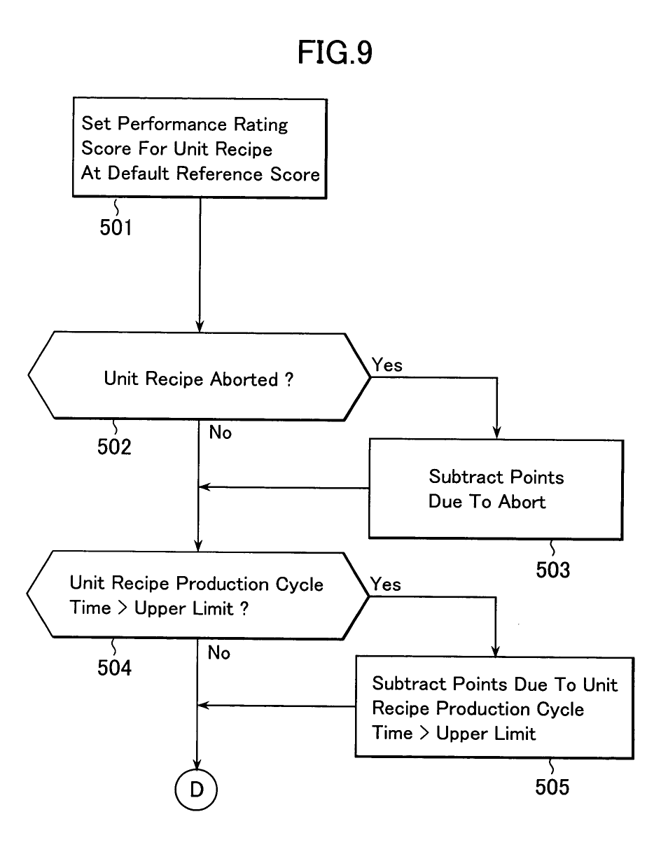

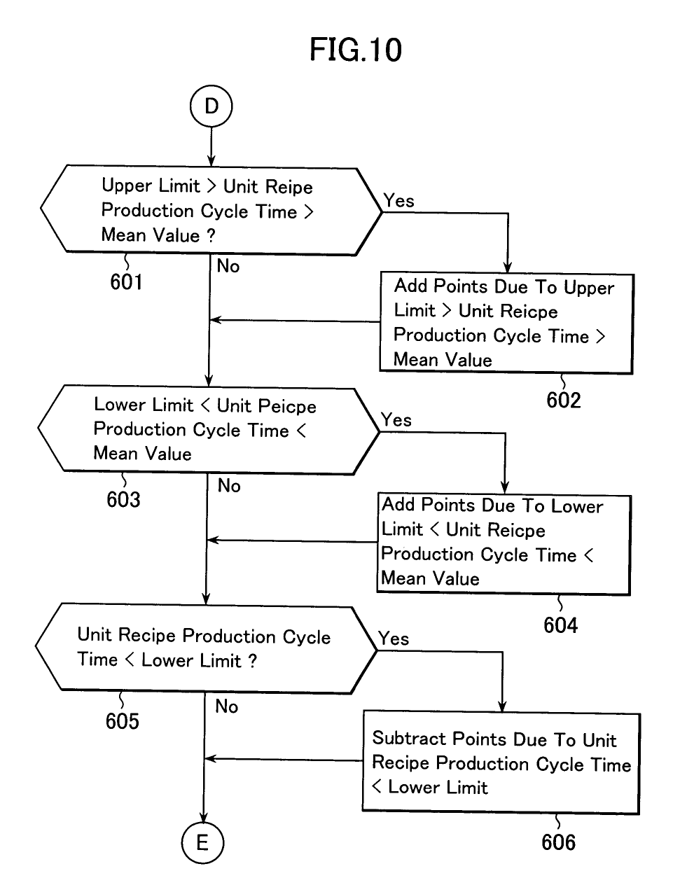

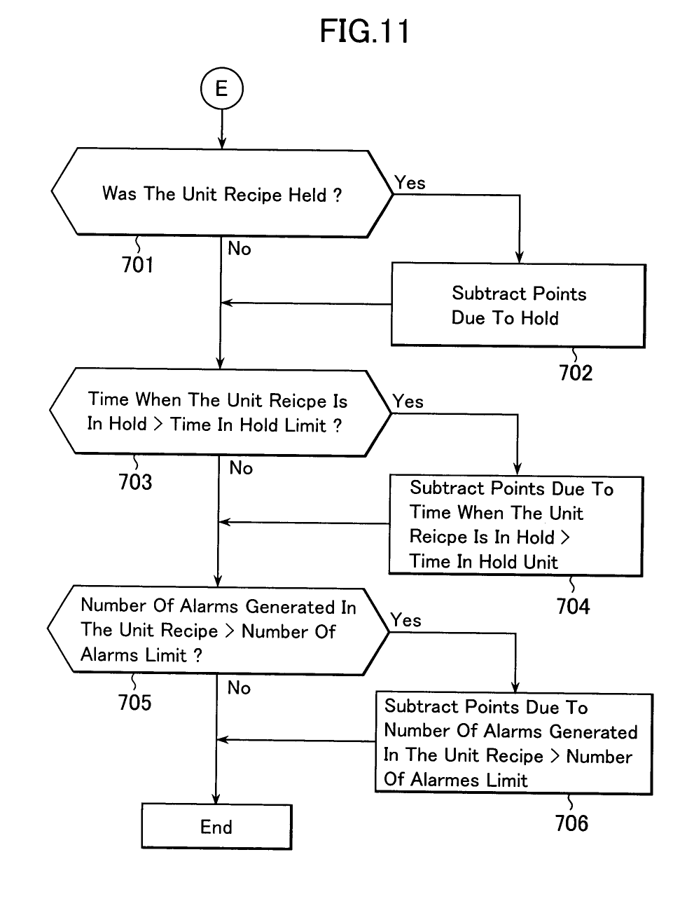

A procedure for performing rating using an apparatus of according to an embodiment will now be described. FIGS. 5 to 11 are flowcharts showing the rating procedure. The procedure includes many steps and therefore is shown in plural drawings. A symbol following the last step in each drawing continues to a symbol prior to the first step in the next drawing. For example, “A” in FIG. 5 continues to “A” in FIG. 6. The flowcharts will be described in the order of steps.

(Step 101)

It is judged whether or not the number of batches based on the same recipe revision as a recipe revision to be rated (current recipe revision) is equal to or larger than “the minimum number of batches in rating calculation).

(Step 102)

If the result of the judgment at step 101 is Yes, an arithmetic operation for performance rating is started. If the result is No, the arithmetic operation for performance rating is not started. In this example, “the minimum number of batches in rating calculation” is five.

(Step 103)

If the number of batches is equal to or larger than “the minimum number of batches in rating calculation”, a performance rating value is set at a default reference score of 70.

(Step 104)

A mean value of the production cycle time of batches based on the same revision as the current recipe revision is calculated.

(Step 105)

A standard deviation of the production cycle time of batches based on the same revision as the current recipe revision is calculated.

(Step 106)

An upper limit value of the production cycle time of batches is calculated. The upper limit value is (mean value+standard deviation).

(Step 107)

A lower limit value of the production cycle time of batches is calculated. The lower limit value is (mean value−standard deviation).

(Steps 108 to 111)

Similarly, a mean value, a standard deviation, an upper limit value and a lower limit value of the production cycle time for each unit recipe in batches are calculated.

(Step 201)

It is judged whether or not a batch or unit recipe is aborted.

(Step 202)

When it is aborted, points due to the abort (25 points) are subtracted from the current performance rating score.

(Step 203)

It is judged whether or not the production cycle time of batches exceeds the upper limit value.

(Step 204)

If it exceeds the upper limit value, points due to the excess over the upper limit value (20 points) are subtracted from the current performance rating score.

(Step 205)

It is judged whether or not the production cycle time of batches is between the upper limit value and the mean value.

(Step 206)

If the production cycle time is between the upper limit value and the mean value, points due to the production cycle time being between the upper limit value and the mean value (10 points) are added to the current performance rating score.

(Step 301)

It is judged whether or not the production cycle time of batches is between the lower limit value and the mean value.

(Step 302)

If the production cycle time is between the lower limit value and the mean value, points due to the production cycle time being between the lower limit value and the mean value (15 points) are added to the current performance rating score.

(Step 303)

It is judged whether or not the production cycle time of batches is less than the lower limit value.

(Step 304)

If the production cycle time is less than the lower limit value, points due to the production cycle time being less than the lower limit value (20 points) are subtracted from the current performance rating score.

(Step 305)

It is judged whether or not the production cycle time for any unit recipe exceeds the upper limit value.

(Step 306)

If the production cycle time exceeds the upper limit value, points due to the excess over the upper limit value (10 points) are subtracted from the current performance rating score.

(Step 401)

It is judged whether or not the batch or any unit recipe was held.

(Step 402)

If it was held, points due to the hold (10 points) are subtracted from the current performance rating score.

(Step 403)

It is judged whether or not the time when the batch or any unit recipe is in hold exceeds a “time in hold limit (%)”.

(Step 404)

If the time when the batch or any unit recipe is in hold exceeds the “time in hold limit (%)”, points due to the excess over the time in hold limit (15 points) are subtracted from the current performance rating score.

(Step 405)

It is judged whether or not the number of alarms generated in the batch (only alarms, no event messages included) exceeds the number of alarms limit.

(Step 406)

If the number of generated alarms exceeds the number of alarms limit, points due to the excess over the number of alarms limit (15 points) are subtracted from the current performance rating score.

(Step 501)

The performance rating score for a unit recipe is set at a default reference score.

(Steps 502 to 706)

For a unit recipe, performance rating similar to that for the batch is carried out.

The batch and unit recipe are defined by the International Standard related to batch control ANSI/ISA S88.01.

Meanwhile, the following cases are regarded as exceptional items and no performance rating is carried out in these cases:

(a) in case the batch start time is corrupt, not accurate or missing;

(b) in case the batch end time is corrupt, not accurate or missing; and

(c) in case the value of date or time is corrupt, not accurate or missing.

The following rating items and rating values can be added to the above-described rating items:

(a) sub-processes other than recipe, unit recipe, unit operation and phase;

(b) unproductive state other than hold;

(c) various events other than alarm (for example, the number of manual operations by an operator, the number of messages to an operator, occurrence of important states other than abort, etc.);

(d) various information related to batch production cost (for example, production cost (based on actually used facilities), labor cost, material cost, management cost, etc.);

(e) other key parameters;

(f) quality data from a laboratory;

(g) the quantity of a material that is actually added or consumed;

(h) actual amount of production;

(i) difference and achievement of recipe items

(j) data related to facilities;

(k) personal data of an operator who took part in production;

(l) data of lot definition and quality of materials; and

(m) data of maintenance related to facilities.

A method for inputting these data is not particularly limited. For example, methods such as text input, graphical input, and input from an electronic file (text editor, word processor, XML file, etc.) may be used.

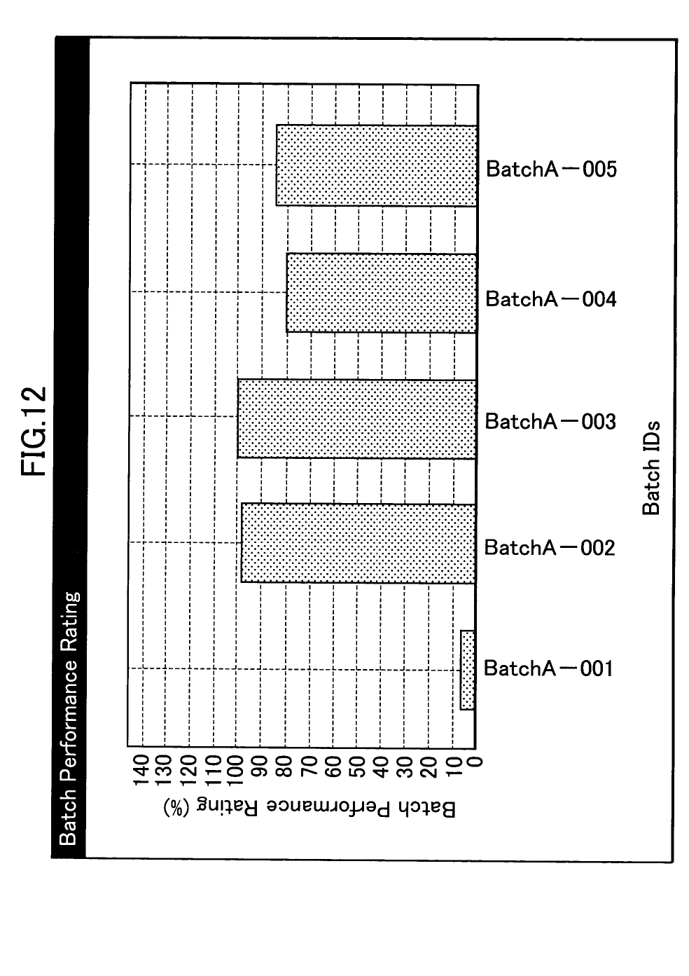

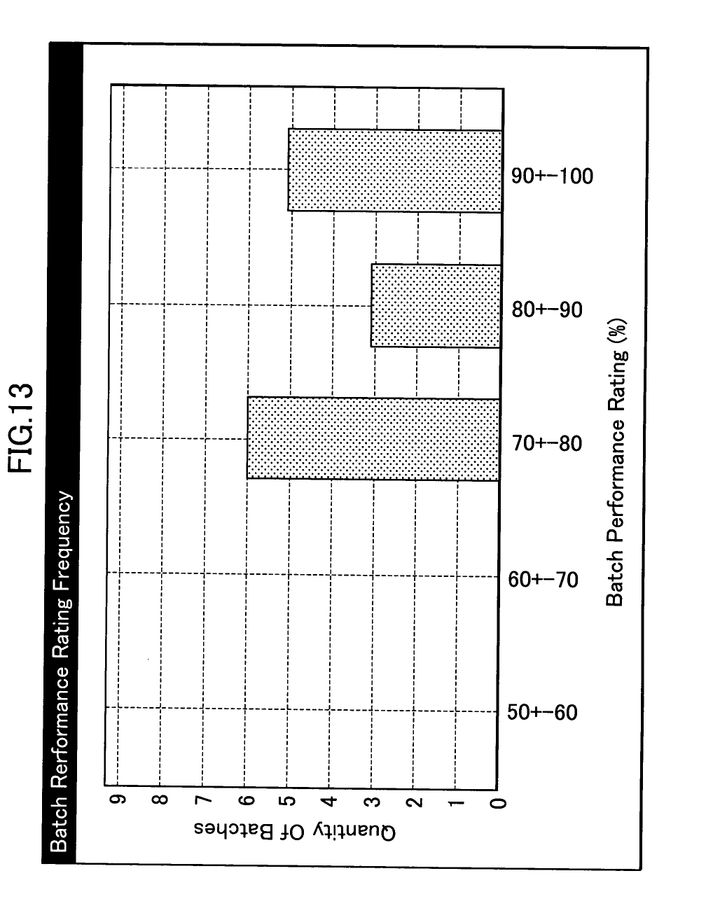

FIGS. 12 and 13 show exemplary displays of the result of performance rating.

In FIG. 12, the horizontal axis represents batch ID and the vertical axis represents performance rating value of 0 to 140%. FIG. 12 is a chart showing an analysis of variation in the performance rating for each batch.

In FIG. 13, the vertical axis represents the number of batches and the horizontal axis represents performance rating value sectioned into ranges of 50 to 60%, 60 to 70%, 70 to 80%, 80 to 90%, and 90 to 100%. FIG. 13 is achart showing an analysis of the frequency of variation in the batch performance rating.

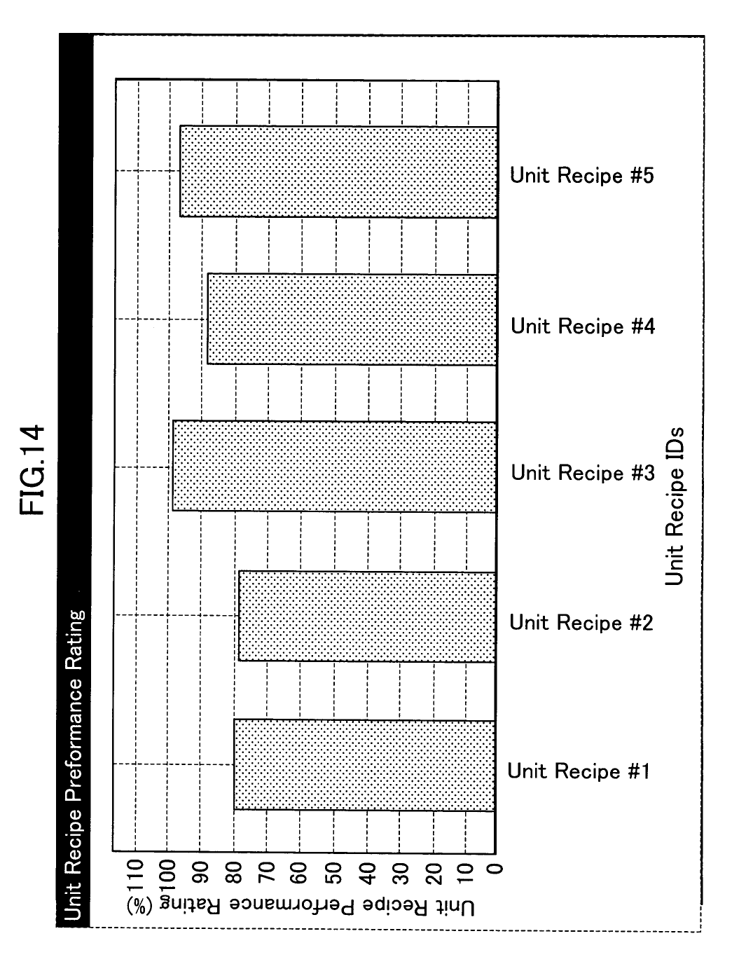

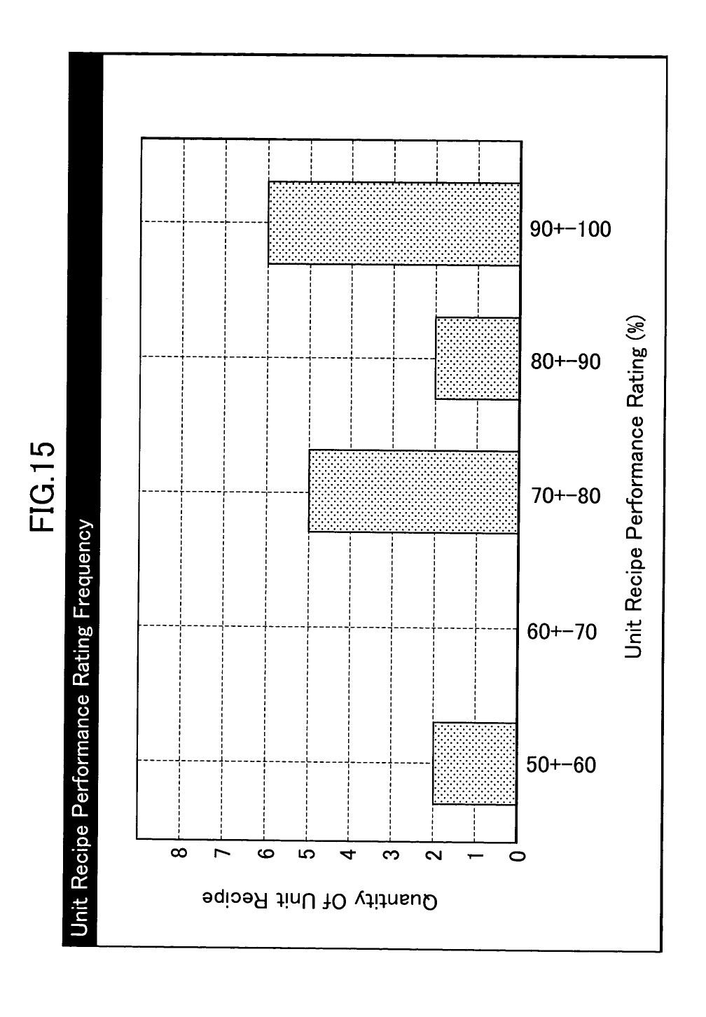

FIGS. 14 and 15 are charts showing similar analyses for a unit recipe.

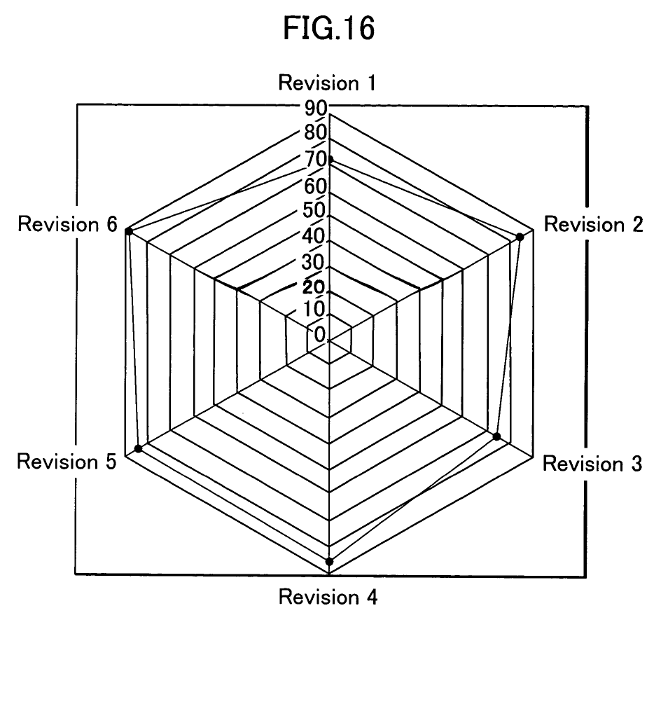

FIG. 16 shows another exemplary display of the result of performance rating.

FIG. 16 shows the results of performance rating based on different revisions with respect to the same basic recipe in the form of radar chart. In FIG. 16, rating values based on revisions 1 to 6 are shown. Also mean values are shown for comparison.

In the above-described exemplary displays, vertical bar graphs and a radar chart are used, but the form of the display is not limited to these. For example, a circle graph, a line graph, a pie chart and the like may be used.

With the charts provided in this invention, it is possible to rate data from various viewpoints and comprehensively analyze the data, instead of the conventional one-dimensional data analysis.

In the embodiment, the performance rating of a batch process is described. However, this invention can also be applied to continuous processes and discontinuous processes other than a batch process.

For example, this invention can be applied to the following continuous processes.

(a) In a continuous distillation process, performance rating is carried out and data is analyzed every time the kind of crude oil is switched.

(b) In an ethylene preparation process at a petrochemical plant, performance rating is carried out and data is analyzed in accordance with the grade of naphtha as a raw material.

(c) In a steam cracking furnace using a continuous process at a paper pulse production plant, performance rating is carried out and data is analyzed depending on a wooden material (needleleaf tree, broadleaf tree or others) to be used as a raw material.

In these cases, continuous data is sectioned at switching timing or at the time of feeding the material, and performance rating depends on the material and operation conditions.

In the case of a discontinuous process, which is easier than a continuous process, most data are managed by each lot and performance rating is carried out in accordance with materials and operation conditions used in each lot.

When batch ID or unit recipe ID is selected on the displays of FIGS. 12 to 14, graphs showing rating achievement data of production cycle time, amount of production, time in hold and the like for the selected batch ID or unit recipe ID may be called up onto the screen. This is realized by the following construction.

A display unit displays, for example, bar graphs for the results of rating as shown in FIGS. 12 to 14 on the screen.

A graph preparation unit prepares a rating achievement data graph for each batch ID or unit recipe ID from rating achievement data with respect to rating parameters such as production cycle time, amount of production and time in hold. The rating achievement data graph is stored in a memory. The rating achievement data is data calculated by comparing achievement data acquired by executing a batch process with a mean value and a standard deviation. For example, the rating achievement data is calculated by the KPIs technique described in the conventional technique.

A selector unit for selecting one of bar graphs displayed on the screen is provided. As a bar graph is selected by this selector unit, a call-up unit calls up a rating achievement data graph including the batch ID or unit recipe ID of the selected bar graph, onto the screen. In this case, a bar graph is displayed which shows, with bars, the rating achievement data of production cycle time, amount of production, time in hold and the like for each batch ID or unit recipe ID. This makes it easier to analyze a cause when a certain batch ID has a low rating value.

This invention provides the following effects.

(1) Plural performance rating items as rating indexes for a production process are prepared in advance, and in accordance with whether or not the currently executed production process satisfies each of the performance rating items, a point or points are added or subtracted, or another arithmetic operation for rating is performed, thus calculating a final rating value. That is, the final rating is based on a combination of the results of rating of the plural performance rating items. This enables comprehensive rating and multilateral analysis of performance of the entire production process.

(2) A production process may be a batch process, a continuous process, or a discontinuous process. Therefore, the performance of the entire batch process, continuous process or discontinuous process can be rated comprehensively and objectively.

(3) A total rating score is decided for each batch process or for each unit recipe in the batch process. Therefore, performance rating can be made for each batch process or for each unit recipe.

(4) When the batch production cycle time is between the upper limit value and the lower limit value, the arithmetic unit adds a rating value to the reference score. When the batch production cycle time is more than the upper limit value or less than the lower limit value, the arithmetic unit subtracts a rating value from the reference score. This enables proper rating of the batch production cycle time.

(5) Since rating is carried out when the number of times a batch based on the same recipe revision is executed is a predetermined number or more, highly reliable performance rating can be carried out without being affected by temporal changes.

(6) Since the result of performance rating is displayed in a graph in which one coordinate axis represents rating score and the other coordinate axis represents batch ID or unit recipe ID, variation in the performance rating for each batch can be easily recognized.

(7) Since the result of performance rating is displayed in a graph in which one coordinate axis represents the number of batches or the number of unit recipes and the other coordinate axis represents sections of the total rating score, the frequency of variation in the performance rating for the batch can be easily recognized.

(8) Since the display unit displays the result of rating in a bar graph, a line graph, a circle graph, a radar chart or a graph plotting the total rating score, the result of rating can be displayed in an easily recognizable form.

(9) As a bar graph showing the result of rating displayed on the screen is selected, a rating achievement data graph including batch ID or unit recipe ID based on the selected bar graph is called up onto the screen. The rating achievement data graph is a graph showing the rating achievement with respect to rating parameters for each data batch ID or unit recipe ID. This enables easy and objective analysis of a cause when a certain batch ID or unit recipe ID has a low rating value.

What is claimed is:

1. A production process rating method for rating a production process on the basis of a predetermined rating standard, the method comprising
preparing in advance plural data including performance rating items associated with rating values as rating indexes for a production process and storing the data into a memory, gathering achievement data by a gathering unit when the production process is executed, judging by an arithmetic unit whether or not the executed production process satisfies conditions defined by the performance rating items on the basis of the gathered achievement data, adding or subtracting a point or points to or from the rating values or performing another arithmetic operation for rating in accordance with the result of the judgment, and comprehensively rating the production process on the basis of the plural performance rating items.

2. The production process rating method as claimed in claim 1, wherein a reference score is set as a default value in starting to rate the production process, and the arithmetic unit adds or subtracts a rating value from the reference score or performs another arithmetic operation for rating in accordance with the result of judgment made for each performance rating item, thereby deciding an ultimate total rating score.

3. The production process rating method as claimed in claim 1 or 2, wherein the production process is a batch process.

4. The production process rating method as claimed in claim 1 or 2, wherein the production process is a continuous process or a discontinuous process.

5. The production process rating method as claimed in claim 3, wherein a total rating score is decided for each batch process or for each unit recipe in the batch process.

6. The production process rating method as claimed in claim 3, wherein when a batch production cycle time is between an upper limit value and a lower limit value, the arithmetic unit adds a rating value or performing another arithmetic operation for rating to the reference score.

7. The production process rating method as claimed in claim 3, wherein when a batch production cycle time is more than an upper limit value or less than a lower limit value, the arithmetic unit subtracts a rating value or performing another arithmetic operation for rating from the reference score.

8. The production process rating method as claimed in claim 3, wherein rating is carried out when the number of times a batch based on the same recipe revision is executed is a predetermined number or more

9. A production process rating apparatus for rating a production process on the basis of a predetermined rating standard, the apparatus comprising:
a storage unit for storing plural data including performance rating items associated with rating values as rating indexes for a production process;
a gathering unit for gathering achievement data when the production process is executed;
an arithmetic unit for judging whether or not the executed production process satisfies conditions defined by the performance rating items on the basis of the achievement data, adding or subtracting a point or points to or from the rating values or performing another arithmetic operation for rating in accordance with the result of the judgment, and comprehensively rating the production process on the basis of the plural performance rating items; and
a display unit for displaying on a screen a graph based on the result of the rating by the arithmetic unit, with one coordinate axis representing total rating score and the other coordinate axis representing batch ID or unit recipe ID.

10. A production process rating apparatus for rating a production process on the basis of a predetermined rating standard, the apparatus comprising:
a storage unit for storing plural data including performance rating items associated with rating values as rating indexes for a production process;
a gathering unit for gathering achievement data when the production process is executed;
an arithmetic unit for judging whether or not the executed production process satisfies conditions defined by the performance rating items on the basis of the achievement data, adding or subtracting a point or points to or from the rating values or performing another arithmetic operation for rating in accordance with the result of the judgment, and comprehensively rating the production process on the basis of the plural performance rating items; and
a display unit for displaying on a screen a graph based on the result of the rating by the arithmetic unit, with one coordinate axis representing the number of batches or the number of unit recipes and the other coordinate axis representing sections of a total rating score.

11. The production process rating apparatus as claimed in claim 9 or 10, wherein the display unit displays the result of the rating in a bar graph, a line graph, a circle graph, a radar chart, or a graph plotting a total rating score.

12. The production process rating apparatus as claimed in claim 9, wherein the display unit displays the result of the rating for each batch ID or unit recipe ID in a bar graph on a screen, the apparatus further comprising:
a graph preparation unit for preparing a rating achievement data graph for each batch ID or unit recipe ID from rating achievement data with respect to rating parameters;
a selector unit for selecting one of bar graphs displayed on the screen; and
a call-up unit for calling up a rating achievement data graph including batch ID or unit recipe ID based on the selected bar graph onto the screen.
